(19) United States
(12) Patent Application Publication
(10) Pub. No.: US 2019/0242468 A1
(43) Pub. Date: Aug. 8, 2019

(54) TOOTHED WHEEL

(71) Applicant: Miba Sinter Austria GmbH, Laakirchen (AT)

(72) Inventors: Wolfgang SCHIMPL, Scharnstein (AT); Markus SCHAUER, Gunskirchen (AT); Alexander MUELLER, Altmuenster (AT)

(73) Assignee: Miba Sinter Austria GmbH, Laakirchen (AT)

(21) Appl. No.: 16/208,740

(22) Filed: Dec. 4, 2018

(30) Foreign Application Priority Data
Feb. 8, 2018 (AT) A 50119/2018

(51) Int. Cl. F16H 55/17; F16H 55/08

(52) U.S. Cl. CPC F16H 55/17; F16H 55/08

(57) ABSTRACT

A toothed wheel has a hub part, a web part and a toothed crown, wherein at least one transition region having a rounding is formed in the web part and the transition region has a height h in an axial direction of the toothed wheel and a length L in a radial direction, and wherein the toothed crown of the toothed wheel has a maximum width A and the web part has a minimum width B, each in the axial direction of the toothed wheel, wherein the maximum width A is larger than the minimum width B. The rounding is situated within a band that is calculated from the formula y=L*(K₆*(K₇*x)⁶+K₅*(K₇*x)⁵+K₄*(K₇*x)⁴+K₃*(K₇*x)³+K₂*(K₇*x)²+K₁*(K₇*x)¹)+h and a bandwidth of ±50% of the height h, wherein: h=0.375*(A−B), L=2*h, K₁=−3.5855/L, K₂=5.4612/L, K₃=−4.8237/L, K₄=2.2556/L, K₅=−0.5227/L, K₆=0.0473/L, K₇=3.36/L.

### CROSS REFERENCE TO RELATED APPLICATIONS

Applicant claims priority under 35 U.S.C. § 119 of Austrian Application No. A 50119/2018 filed Feb. 8, 2018, the disclosure of which is incorporated by reference.

### BACKGROUND OF THE INVENTION

### 1. Field of the Invention

The invention relates to a toothed wheel with a hub part, a web part and a toothed crown, wherein the web part is disposed between the hub part and the toothed crown, wherein at least one transition region with a rounding is formed in the web part and the transition region has a height h in an axial direction of the toothed wheel and a length L in a radial direction, and wherein the toothed crown of the toothed wheel has a maximum width A and the web part has a minimum width B, each in the axial direction of the toothed wheel, wherein A is larger than B.

### 2. Description of the Related Art

For reduction of the energy consumption, efforts have already been made for some time to make vehicles lighter. All vehicle components are affected by this, including toothed wheels. For example, DE 10 2007 013 829 A1 describes a weight-reduced toothed wheel having a hub and having a ring equipped with a toothing, wherein the hub is connected to the ring via a disk part equipped with at least one recess, wherein the disk part is equipped on both sides in axial direction of the axis of rotation of the toothed wheel with a substantially disk-shaped cover.

A weight-reduced toothed wheel with a toothed crown provided with a toothing and connected via a web zone to a hub is also known from DE 10 2009 012 812 A1. For this purpose, the material distribution in the region of the web zone is adapted to the stresses occurring during operation and, for example, an asymmetrically material distributon relative to a central plane of the toothed wheel is provided in the region of the web zone.

### SUMMARY OF THE INVENTION

The task of the present invention consists in the creation of a possibility for further weight reduction of a toothed wheel.

The task of the invention is accomplished in the toothed wheel mentioned in the introduction by the fact that the rounding is situated within a band that is calculated from the formula y=L*(K₆*(K₇*x)⁶+K₅*(K₇*x)⁵+K₄*(K₇*x)⁴+K₃*(K₇*x)³+K₂*(K₇*x)²+K₁*(K₇*x)¹+h and a bandwidth of ±50% of h around the value y, wherein h=0.375*(A−B), L=2*h, K₁=−3.5855/L, K₂=5.4612/L, K₃=−4.8237/L, K₄=2.2556/L, K₅=−0.5227/L, K₆=0.0473/L and K₇=3.36/L.

In the course of the development of toothed wheels, the inventors were able to find that, under certain conditions, which are indicated in the foregoing, a further reduction of the axial width of the web part of a toothed wheel is possible. By the compliance with this condition of the rounding structure in the at least one transition region, stresses occurring may be reduced or better distributed. Thus the reduction of the width of the web part and the weight reduction are possible, since less material must be reserved for the mechanical loadability of the toothed wheel.

A further improvement of these effects may be achieved when the rounding exactly follows the formula indicated in the foregoing: y=L*(K₆*(K₇*x)⁶+K₅*(K₇*x)⁵+K₄*(K₇*x)⁴+K₃*(K₇*x)³+K₂*(K₇*X)²+K₁*(K₇*x)¹+h, i.e. the bandwidth of the band on the curve function is inherently reduced.

According to a preferred embodiment variant of the toothed wheel, the transition region having the rounding is formed between the web part and the toothed crown and/or between the web part and the hub part, since stress peaks are able to occur in particular in these regions during operation of the toothed wheel.

For reasons of weight reduction, however, it may also be provided that several recesses and/or openings, between which webs are disposed, are formed in the web part, wherein the transition regions having the rounding are formed respectively between the recesses and/or openings and the webs, whereby these “problem sites” can be better controlled in terms of the occurring stresses.

Although a lessening of the weight reduction is associated with this, it may also be provided, for an increase of the mechanical strength, that the web part, viewed in axial direction, becomes broader in the rounding region in the direction of the recesses and/or openings.

For further reduction of the toothed-wheel weight, it may be provided that the transition region having the rounding at the transition between the web part in the toothed crown and/or at the transition between the web part in the hub part merges into a cylindrical region, which extends in axial direction. Thus the transition region does not extend as far as the axial end faces.

### BRIEF DESCRIPTION OF THE DRAWINGS

For better understanding of the invention, it will be explained in more detail on the basis of the following figures.

Therein, respectively in simplified schematic diagrams,

FIG. 1 shows a first embodiment variant of a toothed wheel in oblique view;

FIG. 2 shows a section from the toothed wheel according to FIG. 1 in cross section;

FIG. 3 shows a section from a curve profile of the rounding;

FIG. 4 shows a second embodiment variant of a toothed wheel in oblique view;

FIG. 5 shows a section from the toothed wheel according to FIG. 4 in cross section;

FIG. 6 shows a section from a toothed wheel that is not in accordance with the invention;

FIG. 7 shows a section from a second toothed wheel that is not in accordance with the invention;

FIG. 8 shows a section from a third toothed wheel that is not in accordance with the invention.

### DETAILED DESCRIPTION OF PREFERRED EMBODIMENTS

By way of introduction, it is pointed out that like parts in the differently described embodiments are denoted with like reference symbols or like structural part designations, wherein the disclosures contained in the entire description can be carried over logically to like parts with like reference symbols or like structural-part designations. The position indications chosen in the description, such as top, bottom, side, etc., for example, are also relative to the figure being directly described as well as illustrated, and these position indications are to be logically carried over to the new position upon a position change.

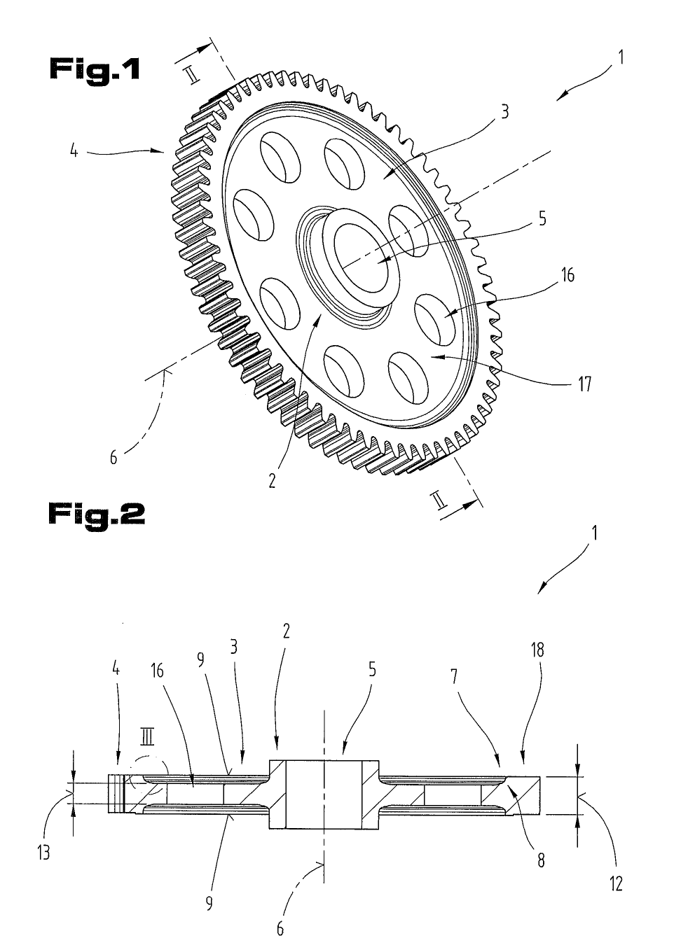

FIGS. 1 to 5 show several embodiment variants of a toothed wheel 1 or sections thereof. What is common to these toothed wheels 1 is that they each have a hub part 2 (which may also be called a hub portion), a web part 3 (which may also be called web portion) and a toothed crown 4. The hub part 2 serves for arrangement of the toothed wheel 1 on a shaft or the like, for which purpose the hub part 2 may have an opening 5 in an axial direction 6.

The web part 3 is formed directly adjoining the hub part 2 in radial direction.

The web part 3 carries the toothed crown 4, for which purpose the latter may be formed directly adjoining the web part 3 in radial direction.

The toothed crown 4 has, not illustrated in more detail, a toothing with teeth. As an example, the toothing may be constructed as a straight toothing or helical toothing.

The web part 3 is made thinner in the axial direction 6 than is the hub part 2 and/or the toothed crown 4.

In general, the web part 3 may extend in radial direction by between 40% and 80% over a height of the toothed wheel 1. In the preferred embodiment variants of the toothed wheel 1, the rest of the radial height is distributed among the toothed crown 5 and the hub part 2, wherein the opening 5 of the hub part may amount to between 15% and 40% of the radial height of the toothed wheel 1 and the toothed crown to between 10% and 35% of the radial height of the toothed wheel 1.

Furthermore, the web part 3 may have a width in axial direction 6 that is selected from a range of 20% to 98%, especially of 30% to 95% of the width of the toothed crown 5 in the axial direction 6.

The radial height of the toothed wheel 1 corresponds to the radius of the tip-circle diameter of the teeth of the toothing.

Preferably, the toothed wheel 1 is manufactured as a metallic sintered structural part by a powder-metallurgical process. Since these processes are known in principle, further explanations of them are not needed. All that needs to be mentioned is that a powder-metallurgical process comprises the pressing of a metallic powder to a green compact, the sintering of the green compact and, if necessary, the post-processing of the sintered toothed wheel 1, such as by forming to size and/or hardening, for example.

The toothed wheel 1 is preferably made in one piece, but may also be made in multiple pieces.

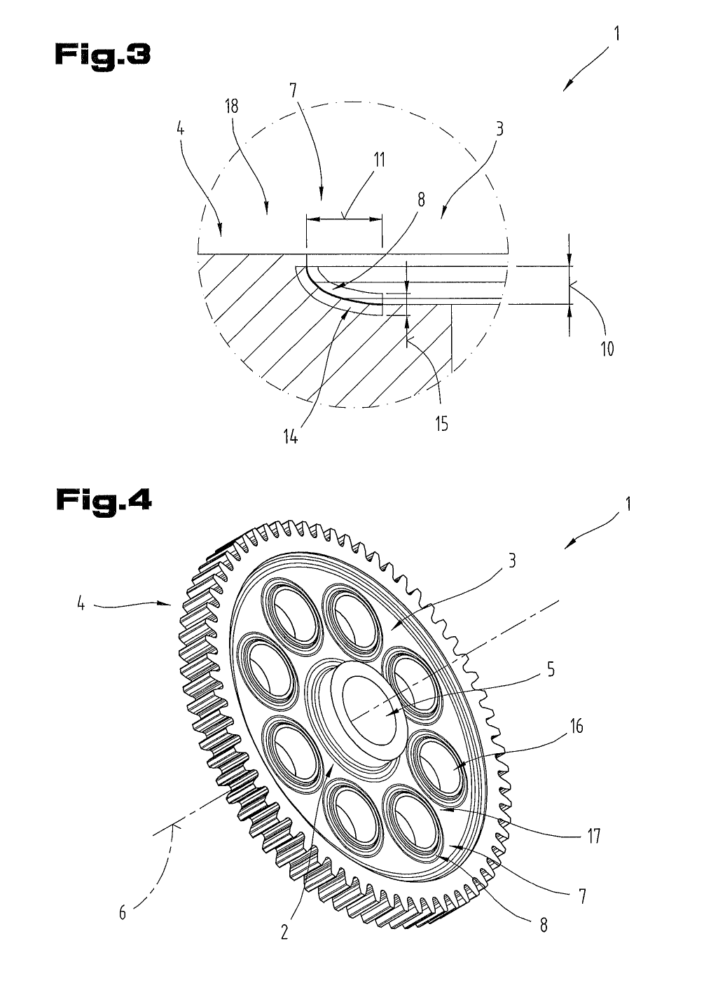

As is best visible from FIGS. 2 and 3, the web part 3 has at least one transition region 7 with a rounding 8.

The at least one transition region 7 is formed on or disposed in an axial end face 9 (FIG. 2) of the toothed wheel 1, i.e. of the web part 3. In this connection, the axial end face 9 is that face which laterally bounds the toothed wheel 1. The normal vector of this end face runs parallel to the axial direction 6 (outside the transition region 7).

In the embodiment variant of the toothed wheel 1 illustrated in FIGS. 1 to 3, one transition region 7 each between the hub part 2 and the web part 3 and between the web part 3 and the toothed crown 4 is disposed or formed on both sides, i.e. on or in both axial end faces 9. In total, therefore, four such transition regions are present.

However, it is also possible for only one transition region 7 to be present per axial end face 9 or even for only one transition region 7 (between web part 3 and hub part 2 or between web part 3 and toothed crown 4) to be present at all on the toothed wheel 1, although these are not preferred embodiment variants of the toothed wheel 1. Preferably, the toothed wheel 1 is symmetrically designed.

In the following, only one transition region 7 will be further discussed, since preferably all transition regions 7 between the hub part 2 and the web part 3 and between the web part 3 and the toothed crown 4 are designed according to the invention, especially identically.

The transition region 7 of this embodiment variant therefore defines the transition from the web part 3 to another part of the toothed wheel 1, i.e. the hub part 2 or the toothed crown 4. The transition region 7 begins where the rounding starts in the web part 3 and ends where the rounding ends at the boundary between the hub part 2 and the toothed crown 4. In this connection, however, the transition region 7 still belongs to the web part 3, and therefore is not an element of the hub part 2 or of the toothed crown 4.

As is visible from FIG. 3, the transition region has a height h 10 and a length L 11. This height h 10 is that height that the curve which forms the rounding crosses over, in the direction of the normal to the end face 9, between two faces disposed perpendicular to one another, as is visible in FIGS. 2 and 3, or, if no faces perpendicular to one another are present, between two faces disposed parallel to one another, wherein, in both variants, respectively one face is present at the beginning of the curve and the further face is present at the end of the curve. One of these two faces is formed by the end face 9.

The length L 11 is that length in radial direction of the toothed wheel 1 which the curve needs for the crossing-over of the height h 10, as is likewise visible from FIGS. 2 and 3.

As is visible from FIG. 2, the toothed crown 4 of the toothed wheel 1 has a maximum width A 12 in the axial direction 6. In addition, the web part 3 has a minimum width B 13. In addition, the maximum width A 12 is larger than the minimum width B 13.

This maximum width A 12 is the largest width that the toothed crown 4 has in the axial direction 6. In the toothed crown 4, it is possible for regions to be present with width smaller than in comparison therewith in the axial direction 6. Preferably, however, the toothed crown 4 has overall the same width in the axial direction 6.

In contrast, the minimum width B 13 is that width in the axial direction 6 that the web part 3 has in at least one region. Regions with greater width than this in axial direction 6 may also be formed in the web part 3, as will be explained further in the following.

It is now provided that the curve that forms the rounding 8 is situated within a band 14 (FIG. 3), which is calculated from the formula y=length L 11 of the rounding in the radial direction of the toothed wheel 1*(K₆*(K₇*x)⁶+K₅*(K₇*x)⁵+K₄*(K₇*x)⁴+K₃*(K₇*x)³+K₂*(K₇*x)²+K₁*(K₇*x)¹+height h 10 of the rounding in the axial direction 6 and a bandwidth 15 (FIG. 3) of ±50% of h around the value y. Therein:

height h 10 of the rounding in the axial direction 6=0.375*(maximum width A 12 of the toothed crown 4−minimum width B 13 of the web part),

length L 11 of the rounding in the radial direction of the toothed wheel 1=2*height h 10 of the rounding in the axial direction h,

K₁=−3.5855/length L 11 of the rounding in the radial direction of the toothed wheel 1,

K₂=5.4612/length L 11 of the rounding in the radial direction of the toothed wheel 1,

K₃=−4.8237/length L 11 of the rounding in the radial direction of the toothed wheel 1,

K4=2.2556/length L 11 of the rounding in the radial direction of the toothed wheel 1,

K5=−0.5227/length L 11 of the rounding in the radial direction of the toothed wheel 1,

K6=0.0473/length L 11 of the rounding in the radial direction of the toothed wheel 1,

K7=3.36/length L 11 of the rounding in the radial direction of the toothed wheel 1.

According to one embodiment variant of the toothed wheel 1, it may be provided that the rounding 8 of the transition region 7 exactly follows the curve calculated from the formula y=L*(K₆*(K₇*x)⁶+K₅*(K₇*x)⁵+K₄*(K₇*x)⁴+K₃*(K₇*x)³+K₂*(K₇*x)²+K₁*(K₇*x)¹+h, as is indicated in FIG. 3 by the rounding 8 illustrated as a heavy line within the band 14. In this connection, the foregoing conditions are also applicable with respect to L, h and K1 to K7.

Merely for completeness, it is pointed out that the hub part 2 may be broader in the axial direction 6 than is the toothed crown 4.

According to another embodiment variant of the toothed wheel 1, it may be provided that several recesses and/or openings 16 are formed (in the axial direction 6) in the web part, as is likewise visible from FIGS. 1 to 5. These recesses and/or openings 16 may have a circular cross section (viewed in the axial direction 6), as is likewise visible from the FIG. However, the recesses and/or openings 16 may have a different form, for example may also be oval or egg-shaped, etc. The shape of the recesses and/or openings 16 illustrated in FIGS. 1 to 5 is therefore not to be understood as limitative. Likewise, the number of recesses and/or openings 16 shown in FIGS. 1 to 5 is not to be understood as limitative.

Webs 17 are formed or disposed between the recesses and/or openings 16. The shape of the webs 17 is dictated by the shape of the and the number of recesses and/or openings 16.

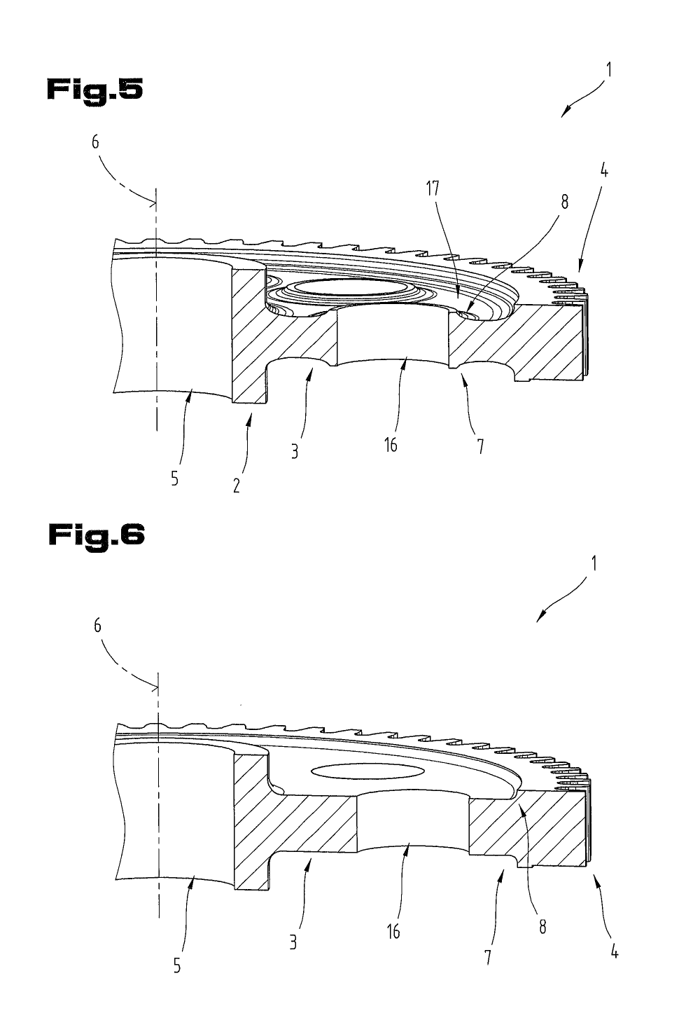

According to another embodiment variant of the toothed wheel 1, it may now be additionally provided that a transition region 7 having the rounding 8 is likewise formed respectively between the recesses and/or openings 16 and the webs 17, as is visible from FIGS. 4 and 5. As regards these transition regions 7 and these roundings 8, the foregoing explanations of the transition region 7 and the rounding 8 of the transition region apply. For example, all roundings 8 may therefore be made identically, although this is not absolutely necessary, as long as the curve of the rounding 8 is situated within the band 14.

According to a further embodiment variant of the toothed wheel 1, it may be provided that, viewed in the axial direction 6, the web part is broader in the direction of the recesses and/or openings in the transition region 7, as is visible in particular from FIG. 5. Thus the web part 3 has a greater width in these transition regions 7 than the minimum width B 13 (FIG. 2), as was already explained in the foregoing. However, this greater width of the web part 3 around the recesses and/or openings 16 is preferably smaller than the maximum width A 12 of the toothed crown 5.

The greater width of the web part 3 around the recesses and/or openings 16 is preferably restricted exclusively to the respective transition region 7 having the length L 11 and the height h 10 corresponding to the foregoing definition.

According to another embodiment variant of the toothed wheel 1, it may be provided that the transition region 7 having the rounding 8 at the transition between the web part 3 in the toothed crown 4 and/or at the transition between the web part 3 in the hub part 2 merges into a cylindrical region 18, which extends in the axial direction 6, as is visible from FIGS. 2 and 3.

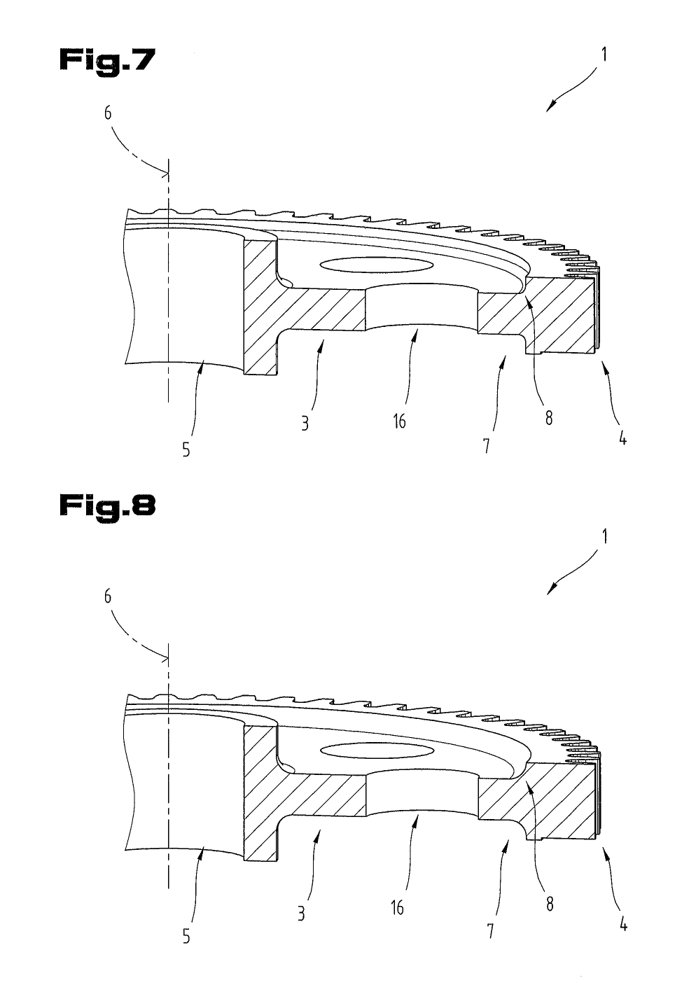

In the course of evaluation of the invention, three toothed wheels 1 corresponding to FIGS. 6 to 8 were manufactured. The toothed wheel 1 according to FIG. 6 was used as reference with 100% mass. In the second toothed wheel according to FIG. 7, only the web part 3 was made smaller, so that the toothed wheel, compared with that according to FIG. 1, from then on had only 85% of its mass. The radius of the rounding 8 in the transition region 7 from the web part 3 to the toothed crown 4 was left the same as in toothed wheel 1 according to FIG. 1. In comparison with this, the radius of the rounding 8 in the transition region 7 from the web part 3 to the toothed crown 4 was increased in comparison with this in the third toothed wheel according to FIG. 8. The toothed wheel 1 according to FIG. 8 had 86% of the mass of the toothed wheel 1 according to FIG. 1.

In addition, one toothed wheel 1 according to FIG. 1 and one toothed wheel 1 according to FIG. 4 were each manufactured. The two toothed wheels had a mass of 86% (FIGS. 1) and 88% (FIG. 4) respectively of that according to FIG. 1.

Subsequently, the stresses in the transition regions 7 were measured at two points of toothed wheels 1. The toothed wheel 1 according to FIG. 6 was defined once again as the 100% stress.

On the basis of the measured values, it was possible to establish that the measured stresses increased significantly to approximately 120% merely by reducing the thickness of the web part 3 (FIG. 7), whereas they remained approximately constant due to the increase of the rounding radius (FIG. 8). In that according to FIG. 1 and FIG. 4, it was possible to achieve a reduction of the occurring stresses by approximately 90% to 95%. Thus it was possible to prove that, despite the reduction of the weight of the toothed wheels 1 according to FIGS. 1 to 5, the mechanical properties are not impaired but can be improved when the foregoing conditions for the roundings 8 in the transition regions 7 are complied with.

The exemplary embodiments show possible embodiment variants of the toothed wheels 1, wherein combinations of the individual embodiment variants with one another are also possible.

Finally, it must be pointed out, as a matter of form, that, for better understanding of the structure of the toothed wheel 1, this is not necessarily illustrated to scale.

Although only a few embodiments of the present invention have been shown and described, it is to be understood that many changes and modifications may be made thereunto without departing from the spirit and scope of the invention.

### LIST OF REFERENCE SYMBOLS

1 Toothed wheel
2 Hub part
3 Web part
4 Toothed crown
5 Opening
6 Axial direction
7 Transition region
8 Rounding
9 End face
10 Height h
11 Length L
12 Maximum width A
13 Minimum width B
14 Band
15 Bandwidth
16 Opening
17 Web
18 Region

1. A toothed wheel (1) with a hub part (2), a web part (3) and a toothed crown (4), wherein the web part (3) is disposed in radial direction between the hub Part (2) and the toothed crown (4), wherein at least one transition region (7) having a rounding (8) is formed in the web part (3) and the transition region (7) has a height h (10) in an axial direction (6) of the toothed wheel (1) and a length L (11) in a radial direction, and wherein the toothed crown (4) of the toothed wheel (1) has a maximum width A (12) and the web part (3) has a minimum width B (13) each in the axial direction (6) of the toothed wheel (1), wherein the maximum width A (12) is larger than the minimum width B (13), wherein the rounding (8) is situated within a band (14) that is calculated from the formula y=L*(K₆*(K₇*x)⁶+K₅*(K₇*x)⁵+K₄*(K₇*x)⁴+K₃*(K₇*x)³+K₂*(K₇*x)²+K₁*(K₇*x)¹)+h and a bandwidth (15) of ±50% of the height h (10), wherein:
h=0.375*(A−B)
L=2*h,
K₁=−3.5855/L,
K₂=−5.4612/L,
K₃=−4.8237/L,
K₄=2.2556/L,
K₅=−0.5227/L,
K₆=0.0473/L,
K₇=3.36/L.

2. The toothed wheel (1) according to claim 1, wherein the rounding (8) follows the indicated formula y=L*(K₆*(K₇*x)⁶+K₅*(K₇*x)⁵+K₄*(K₇*x)⁴+K₃*(K₇*x)³+K₂*(K₇*x)²+K₁*(K₇*x)¹)+h.

3. The toothed wheel (1) according to claim 1, wherein the transition region (7) having the rounding (8) is formed between the web part (3) and the toothed crown (4) and/or between the web part (3) and the hub part (2).

4. The toothed wheel (1) according to claim 1, wherein several recesses and/or openings (16), between which webs (17) are disposed, are formed in the web part (3), wherein respectively the transition regions (7) having the rounding (8) are formed between the recesses and/or openings (16) and the webs (17)

5. The toothed wheel (1) according to claim 4, wherein, viewed in the axial direction (6), the web part (3) is broader in the direction of the recesses and/or openings (16) the transition regions (7).

6. The toothed wheel (1) according to claim 2, wherein the transition region (7) having the rounding (8) at the transition between the web part (3) in the toothed crown (4) and/or at the transition between the web part (3) in the hub part (2) merges into a cylindrical region (18), which extends in the axial direction (6).
